(19) United States
(12) Patent Application Publication
(10) Pub. No.: US 2010/0180570 A1
(43) Pub. Date: Jul. 22, 2010

(54) Reactionless Motion (RM)

(76) Inventor: Luis Dennis Tavarez Tavarez, Manati, PR (US)

Correspondence Address: Luis Dennis Tavarez, Urb. Nuevas Estancias 162, Manati, PR, 00674, US

(21) Appl. No.: 12/355,772

(22) Filed: Jan. 17, 2009

(51) Int. Cl. F02K 99/00; B64G 99/00

(52) U.S. Cl. 60/204

(57) ABSTRACT

The Invention's Project of Reactionless Motion (RM) reveal a mechanically intrinsic motion technic, without motion opposites' reaction, or mass expelling. The RM invention consists in two circular and different reference frames of motion, under the influence of simultaneous attraction and repulsive forces between them. The consequence of said force's influence is a reaction less thrust in the center of each reference frame. Another effects of this invention are non typical observations in terms of propulsion technics, Newton's Third Law of Motion, space-time impulse response, kinetic energy, velocity and rotational motion.

### SPESIFICATIONS

“Not Applicable”

### CROSS-REFERENCE TO RELATED APPLICATIONS

### “Inertial Drives” U.S. Patent Documents

| | | |
|---|---|---|
| 3,584,515 | June 1971 | Matyas |
| 4,631,971 | December 1986 | Thomson |
| 4,712,439 | December 1987 | North |
| 5,966,986 | October 1999 | Virgil |
| 5,831,354 | November 1998 | Stopplecamp |
| 5,782,134 | July 1998 | Bouden |
| 5,335,561 | August 1994 | Harvey |
| 4,712,439 | December 1987 | North |

### BACKGROUND OF THE INVENTION

These papers contains utility patents requirements for an invention pertains to the propellant less propulsion field. The Invention's Project of Reactionless Motion (RM) reveal an intrinsic motion technic, without motion opposites' reaction or mass expelling.

It's a common belief that at this time, the better technic of propulsion in use is the rocket principle. But a lot of people don't know why. Basically, the rocket, use the 50% of total momentum created out the back and the other 50% is loosed in the expelled gas. This fact is a perfect description of the Newton's Third Law of Motion. At this time also exist, a lot of patents that propose “Inertial Drives” that basically in the best cases, suggest a rotational unbalance to get a few % of total momentum in one direction. These inertial drives have a big problems in how they suggest the application of physics principles as their technics of propulsion. The result, is an unusefulness and inefficient propulsion devices. By other way also exist, a lot of patents in electrodynamics, quantum, vortex and other relativistic concepts, that results in a so uncertain and expensive way for trying on prove reaction less propulsion “theories”.

In the followings descriptions in this patent document, we are going to show how to get the best contribution of the Newton's Third Law of Motion in a propulsion technic. As reference to understand how RM works, is an indispensable matter, the knowledge of the science described in the following topics of Physics.

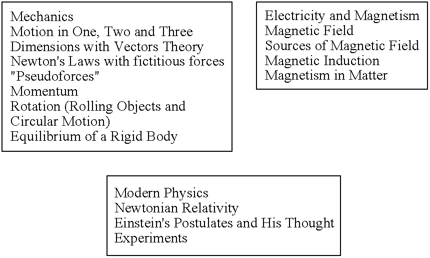

### BRIEF SUMMARY OF THE INVENTION

The RM has no mechanical's dependence of any external medium from itself to gain thrust. It has a free reference frame ability to change its own inertial condition. This ability is mechanically intrinsic. Means, that its own impulse production faculty, always remains at rest, relative to itself. Its motion principle consist on exerted forces between different reference frames together inside itself, for develop all reference frames's motion in the same one way direction, developing also, special properties in “space-time”. The Newton's First Law of Motion (Fnet=ΣF) dose not hold when its motion is observed inside or outside itself, or to explain how its work. Either his Second Law of motion (Fnet=ma). Understanding that, according to both laws, the inertial condition of a body, change as a consequence of an unbalance between something external and other thing no external respect to the body. These descriptions are not electrodynamic theory or rocket technology and there is no proposed mass expelling as an action or reaction. The Newton's Third Law of Motion and Conservation of Momentum explain the rocket propulsion's principle. In this Invention's Project, The Newton's Third Law is applied to explain this propulsion principle, making difference in that the thrust production by the exerted forces is in a perpendicular reference frame relative to the thrust direction. The consequence is a symmetric joint of two force's couples for develop a perpendicular motion action without lineal an opposite reaction. Then, different than the “Inertial Drives” the RM do not suggest an unbalance on a body that first is in rotational motion. And different than rocket principle, in RM, there's no any momentum loosed in the action of motion.

### BRIEF DESCRIPTION OF SEVERAL VIEWS OF THE DRAWINGS

FIG. 1 Show a Reactionlees Motion (RM) device, it's electro magnetization and thrust direction.

FIG. 2 Illustrate the space-time toward the thrust direction. The arrows show force and motion vectors.

FIG. 3 This figure show the attraction and repulsive forces' lines of action. The triangle represents the space relationship between two wheels. The line with cuts, is the common axle.

FIG. 3a Is a drawing of the forces' couples created in the surfaces of the wheels. The arrows show the provoked torque action forces in the axles, the weight, and the reaction exerted by the system's weight that occur tangentially around the wheels axle.

FIG. 4 It's a graphic representation of the basic equivalence in surface distance between line and circle.

FIG. 5 This figure show a graphic equivalence in translation motion between a line and circle or wheel.

FIG. 6 Demonstrate how perpendicular forces exerted on wheel C, create a translation motion as occur in wheel A, without application of rotational force against surface's frictional force like in A

FIG. 7 Demonstrate how the rotational force of a wheel against the surface is equivalent to make the same force against another wheel producing counterclockwise rotation.

FIG. 8 Demonstrate the RM principle comparing with a wheel rolling over a surface.

FIG. 9 This figure is a representation of the phenomena in FIG. 8, making difference on shapes. In this FIG. 9 the arrows represent the attraction and repulsive forces. The biggest arrow illustrated that center of mass is moving too.

FIG. 10 Show the proof of concept initial conditions.

FIG. 11 Show the proof of concept effects.

FIG. M10 Illustrate a wheel rolling condition without slipping.

FIG. M11 Illustrate a wheel rolling condition without slipping in an RM

FIG. A12 Show a RM application on a transport ship.

FIG. A14 Show a RM application on a generator device.

FIG. T15 This drawing show Einstein's Simultaneity Thought Experiment.

FIG. T16 This drawing show a modified Einstein's Simultaneity Thought Experiment.

FIG. T17 Compare the analogous events asynchronous in space-time between Einstein's train and RM.

FIG. T18 Show how in conventional propulsion technics, the impulse response and exerted forces starts and remains always as some synchronous events in the same space-time line.

### DETAILED DESCRIPTION OF THE INVENTION

The FIG. 1 show two free wheels connected in theirs axles and divided along theirs circumferences. These divisions or segments represent very strong electromagnets. The delimited nearest area between the wheels, represent a Polarity Energizers. These Polarity Energizers are direct or alternating current conductors who energize the electromagnets. See, that higher wheel has two positive sides and the lowest wheel has one negative and one positive side. Means, that in lowest wheels, the electric current through the electromagnets, comes to be inverted just in the middle common line of the axles. These Polarity Energizers create a continuos lever arm to keep always a torque between ± and ++ polarity sides. The arrows show the one way direction of the developed inertial change of the wheels “without any medium interaction or mass expelling”.

Scientific Basis

A very long line may imply a conception of a very big space's dimension. An infinite line may be equal to an unceasing way and may imply a conception of an infinite space's dimension. A circle's circumference is equal to an unceasing way but may imply a conception of a small space's dimension. Thinking about this, circle and infinite line may be the same thing with a different presence in space. Observing from dynamics; circle and infinite line may be the same thing with a different presence in space-time.

The first postulate of Albert Einstein's Special Relativity Theory establishes: Absolute uniform motion cannot be detected. If we applied this postulate to a rotation with translation wheel, in a special space system we can observe the following:

1) An observer traveling at constant velocity in an area located like an axle of the wheel, cannot detect if the wheel is rolling over the surface or if the surface is moving in opposite way of the apparent wheel's displacement.

2) Angular Velocity (ω) is present. The same magnitude of ω may be present in a rotational wheel without translation (its axle at rest as inertial condition). Therefore, ω can be present in both inertial conditions for the wheel “the rotational wheel without translation and rolling wheel at constant velocity”.

3) An observer located as a particle on a wheel's dc (differential of circumference) cannot detect either lineal absolute uniform motion on wheel's axle.

From previous remarks, we can identify three reference frames. 1 The axle, 2 The surface, 3 “Any dc”. “Rotational reference frame”

Also, we can conclude the following: [symbol] Delimiting the revolving area of the particle (dc) we can say; “no matter the inertial condition of the wheel, this area always remain at rest relative to the axle. In addition, ω cannot distinguish between rolling motion and surface motion, but ω is required to produce and keep motion between wheel and surface under the influence of a gravitational field or equivalent.

When a slipping wheel has rotation without translation, the approach and withdrawal occur in the same point of the surface. A rolling wheel makes approach and withdrawal from the surface at different points at the same time the axle has displacement. That's indicating the existence of lineal continuos events in space and time acting on perpendicular direction respect to the translation direction of the wheel. These events, can be activated by perpendicular forces respect to the translation, as well the study of physics conventionally express about them as events activated by a rotational couple.

Remember: (circle≈line)=(wheel≈surface)

By example: If we forced these linear continuous events to occur in their respective line of action using two “unceasing ways” (wheels), we can develop their axles' perpendicular displacement.

This displacement cannot be detected between two wheels axles. They only can detect their surfaces' approaches and withdrawals. The displacement can be detected only by an external observer.

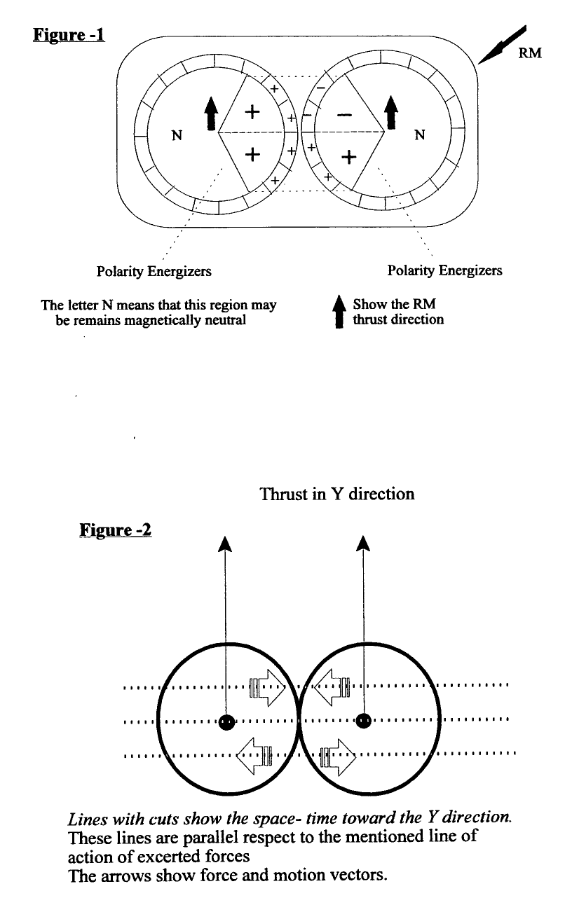

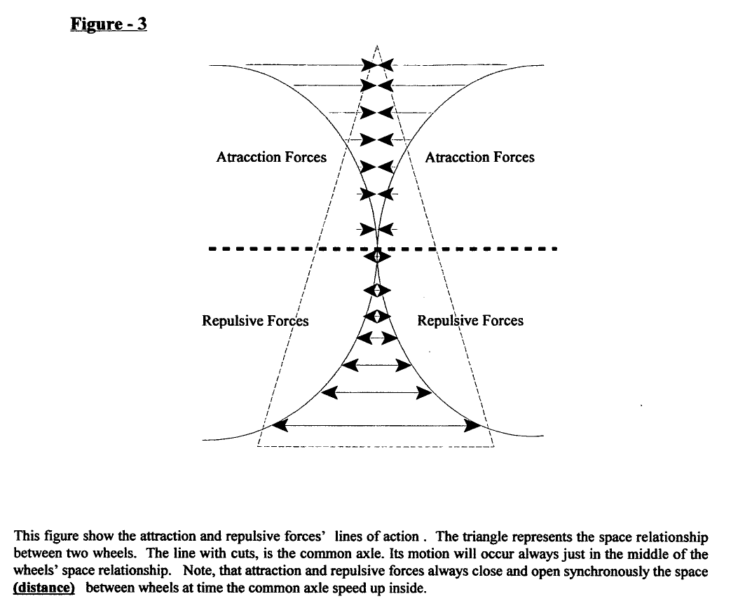

If these events are forced to occur in their respective lines of action so fast as gravity free fall, then we produce levitation of the wheel's axle. If we forced them faster than gravity free fall, then we will get motion against gravity. (See FIG. 2)

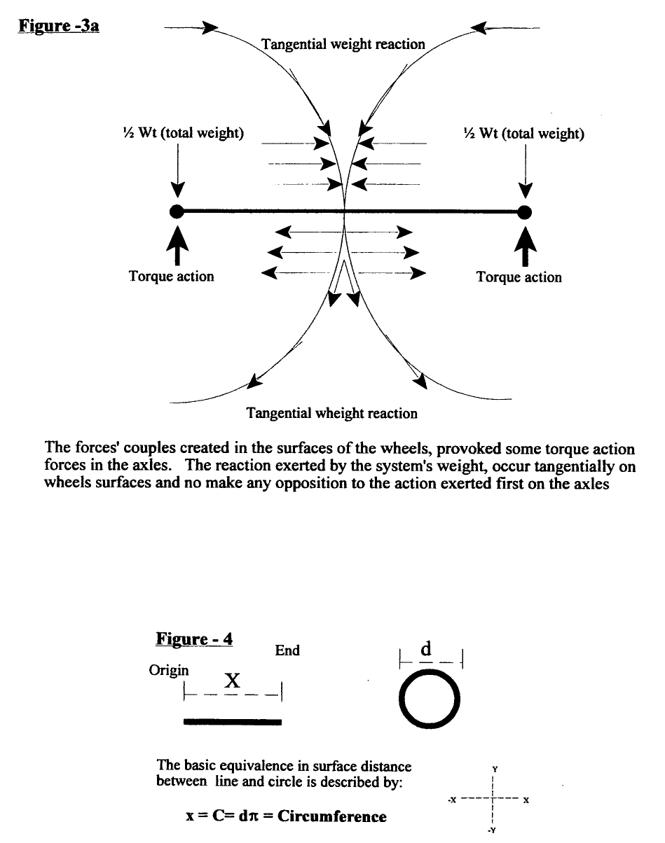

In the FIG. 3, the wheel's axle will get the same acceleration that acting between the wheel's nearest surfaces inside the triangle. The space where the axle exists is just inside the space that is occupied first by the wheels. The space in where the axle is located, close distance in front and open in back respect to the axles acceleration direction.

This is the basis of this reaction less motion of the RM: Newton's Third Law of Motion working in symmetry with circular shapes references frames. Both attraction forces work in action and reaction between them. Also, both repulsive forces work in action and reaction between them. In addition, the action and reaction of attraction forces work perfectly synchronized with the action and reaction of the repulsive forces. In other words, both force couples work as an action or reaction one to each other just in the middle of two “unceasing ways”, and the mechanical faculty of motion remained always at rest relative to its axles.

Observing from torque perception: The forces' couples created in the surfaces of the wheels, provoked some torque action forces in the axles. The reaction exerted by the system's weight, occur tangentially on wheels surfaces and no make any opposition to the action exerted first on the axles, moreover, the reaction make also contribution to the action forces. The reaction put in position immediately another surface's differentials for provoke another torque impulse. When the actions provoked by the couples be grather than weight, then the system simply start it own elevation. (See FIG. 3a)

The motion's cause is perfectly compatible with our Physics, but the motion's effects respect to an external observer, does not respond to the third law of motion. When the motion of each wheel is observed in the space, the momentum generated closing and opening the space (distance) between two wheels, oblige both wheels to take a momentum (impulse) in only one single direction as well happens in a rolling wheel over a surface without slipping.

This technic use the total generated momentum contribution in favor of the thrust, (momentum generated by the attraction an repulsive forces), and this fact represents a better propulsion technic than the rocket principle.

Fundamentals differences between RM and “Inertial Drives” “No obviousness Condition”

The best, or more realistic proposed and/or patented “Inertial Drives” until today has in common the same uneffective principle. This is the principle of making a mass unbalance in a body that is first in a rotational motion to get an impulse in the direction of the unbalance. This principle has the following problems comparing to RM:

1) You will never get from a rotational body a single unidirectional unbalance momentum with a body mass component of a half or more of the total mass without an interaction of an external medium. The invention of the RM use 100% of the momentum generated by the magnefical forces and move 100% of the mass in a single direction.

2) A rotational unbalance of a body implies a reduction of angular momentum, velocity, acceleration, energy, etc. The consequence is a smallest unbalance in the followings rotations. The RM principle implies constant lineal acceleration of the axle at constant angular velocity of the wheels. See FIGS. M-10 and M-11 and derivations

3) The Scientific Basis of the conventional “Inertial Drives” is completely different than the RM Scientific Basis. Cause and effect are completely different concepts in both. In the conventional “Inertial Drives” the rotation is the cause and the unbalance or lineal small impulse is the effect. In the RM, the cause is the lineal attraction and repulsion forces. One of the resultant effects is the rotation of the wheels. Moreover and also different than rocket principle, the RM always has in space—time, its own impulse ability behind and ahead to its own motion response, as shown in FIG. T-17.

More Explanation of the Proposed Invention

Elementary Property of a Circle or Wheel

We can describe a circle or wheel like a straight line with an origin and end, that is uniformly bended until its end and origin remains jointly. This action create an “unceasing way” in a two coordinates plane. See FIG. 4

We know that usually some forces may exist to keep together wheel and surface to create the required friction for allow the wheel or surface displacement.(Friction force) Fₖ=(Normal force) Fn X coefficient of kinetic friction ) μK. These forces and the surface can be transformed as follow.

A wheel rolling over a plane surface will be equal to move the origin of a line ahead to the end of the line, without slipping. See FIG. 5 “Neglecting the line thickness”

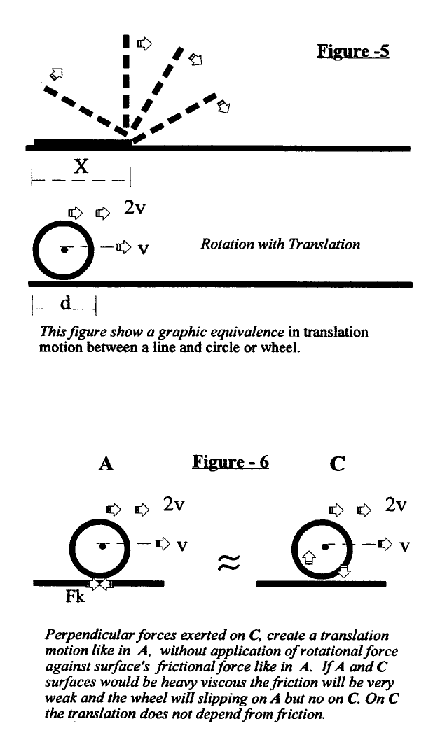

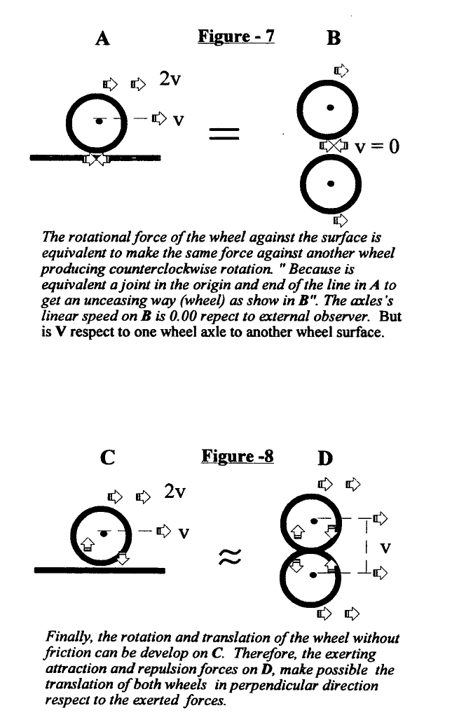

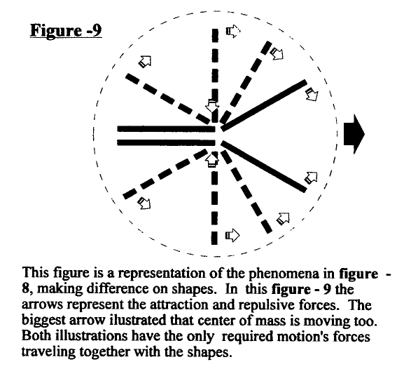

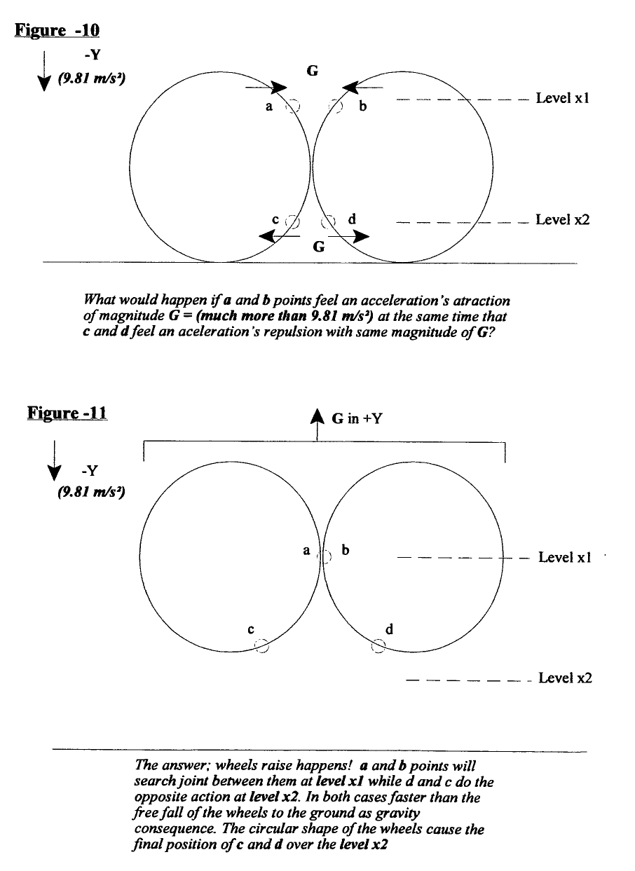

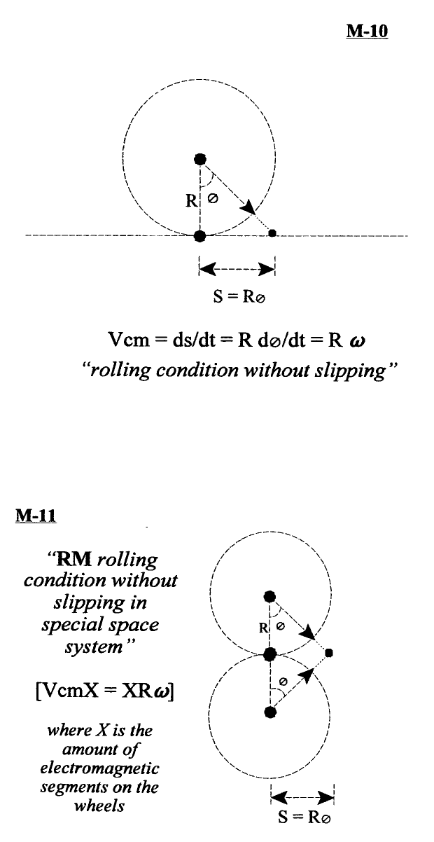

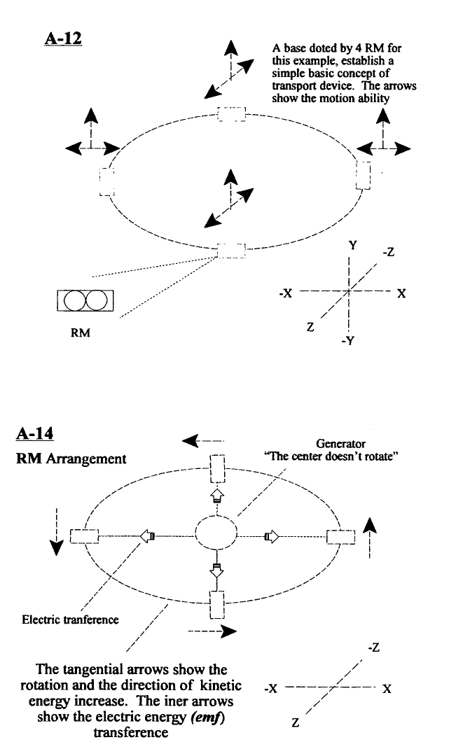

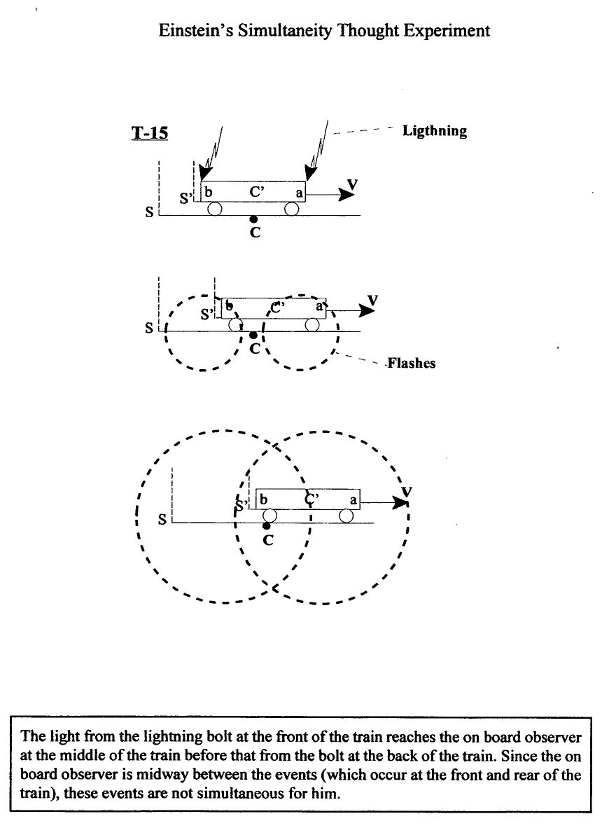

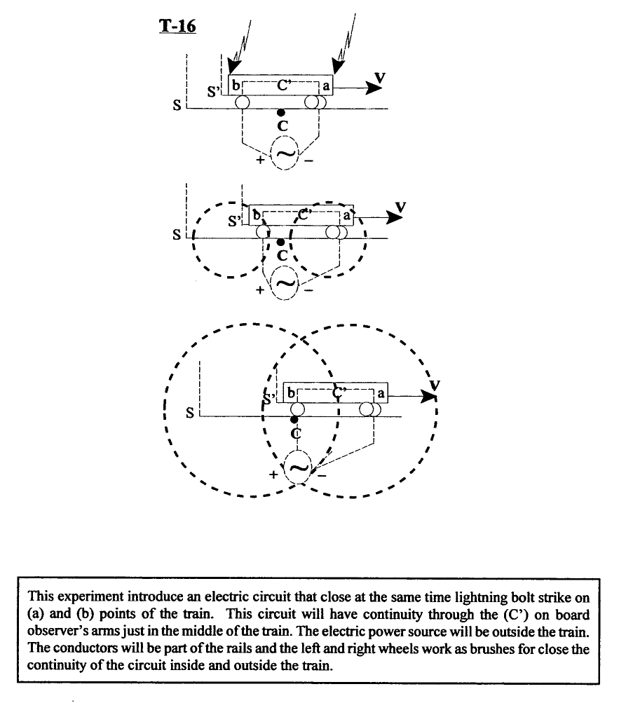

A rolling wheel (uniform banded line) makes approach and withdrawal from the surface at different points at the same time the axle has displacement. When the wheel has rotation without translation, the approach and withdrawal occur in the same point of the surface. That's indicating the existence of lineal continuos events acting on perpendicular direction respect to the translation direction of the wheel. These events, can be activated by perpendicular forces respect to the translation, as well the study of physics conventionally express about them as events activated by a rotational pair. (See FIGS. 6, 7, 8 & 9)

Proof of Concept

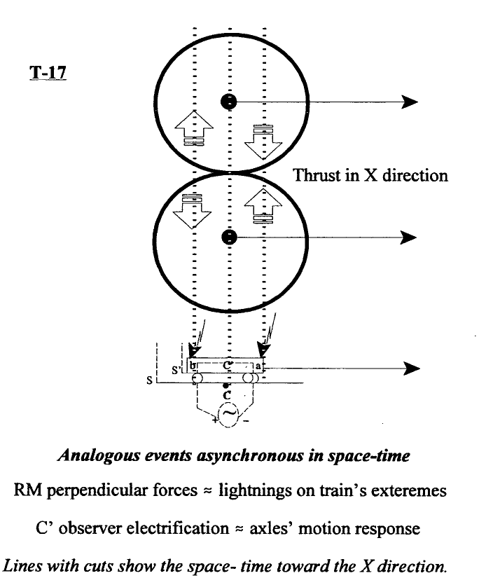

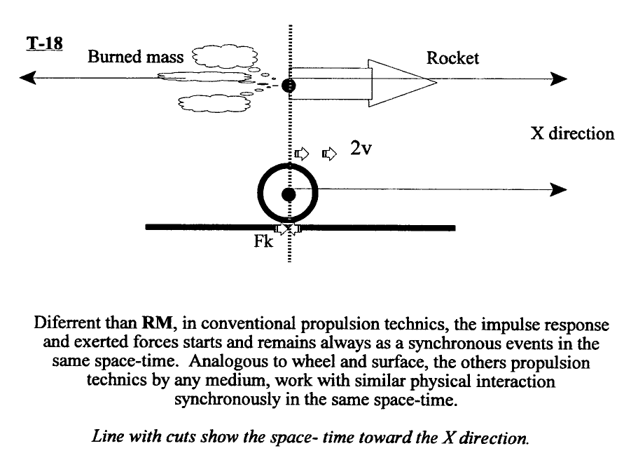

If we take two rings on hand and simulate with fingers the a and b points's acceleration, we can test the simultaneous accelerations of the wheels in a perpendicular direction respect to the exerted forces applied by the fingers. Is easy to prove and understand this principle! (See FIGS. 10 and 11)

Thought Experiments, Applications and Astonishing Effects of RM

Velocity and Acceleration “first astonishing effect”

The velocity of the wheel's center of mass and the angular velocity of rotation are related as shown in FIG. Mathematics-10 (M-10):

For one RM, the velocity of the center of mass and the angular velocity of rotation are related, as shown in FIG. (M-11):

Assuming that the wheels are divided as in FIG. 1 by many segments of electromagnets of distance equal to “s”, the produced velocity in each “s” is related by the same equation: ds/dt=R dø/dt=R ω. This equation define the motion's consequence of each simultaneous attraction and repulsion pulse.

The relation in one single rotation of each wheel is:

V_{1 cm}=ds₁/dt₁=R dø₁/dtᵢ=R ω

V_{2 cm}=V_{1 cm}+ds₂/dt₂=R dø₂/dt₂=2R ω

V_{3 cm}=V_{2 cm}+ds₃/dt₃=R dø₃/dt₃=3R ω

V_{4 cm}=V_{3 cm}+ds₄/dt₄=R dø₄/dt₄=4R ω . . . until V_{x cm} Where s1=s2=s3 . . . =sx

In one RM with wheels divided in X number of electromagnets' segments, the center of mass will be accelerated in the way that its velocity in one single rotation of its wheels will be related by:

[V_{x cm}=XR ω]

The acceleration will be related by: a_{cmx}=XRd²sₓ/dt²ₓ=XRd²øₓ/dt²ₓ

[a_{x cm}=XRα]

In n numbers of rotations the velocity and acceleration of one RM will be related by:

$$[ {Vx}_{cm} = {\sum }_{K = 1}^{n} KXR ω ]$$

$$[ {ax}_{cm} = {\sum }_{K = 1}^{n} KXR α ]$$

Using appropriate electromagnetic force, this description can suggest an “enormous and continuous acceleration” in a short period of time. Different than conventional rolling motion, the derived equation of RM velocity implied an increase of translation speed proportional to KX increase at constant ω. In motion's terms, the effect is equal to roll over a wheel on a surface that roll over on another surface and successively summing more and more surfaces. This description also, is for a special space system where the external observer and RM are in the same inertial condition before RM comes to be activated, and there's no external force exerted on it. However, in a non special space system an appropriate RM device can be develop great motion performance.

Transport Conceptualization “application”

When we talked about the wheel in the last title “Scientific Basis”, one remark was the axle as a reference frame. In FIG. 1 everything that which kept fix to the wheel's axles, will get the axles acceleration. Both free wheels connected between its axles is the physical description of Reactionless Motion RM.

In FIG. Application-12 (A-12) there's four (4) RM on a circular base (for this example) at four equidistant extremes. The RM has the faculty of rotation in each extreme or in other case will have four additional RMS parallel respect to the base. The arrows show the motion's faculty of the base. Its an assumption, like a common transport, that it will place on the base, all related as an electricity generator, controls and everything applicable to a transport device.

Energy Developed by Inertial Change “Other Application and Second Astonishing Effect”

The RM principle suggest constant acceleration of the axles by application of constant force. Means, after RM start its own motion, the kinetic energy increase without need increase start up energy. (from rest observer relative point of view).

In electromagnetism, a constant magnetic force can be hold with constant flux of electric current in coils.

The physics principles of Circular Motion establish that a particle moving in circular form has a tangential, centripetal and/or centrifugal components related between them but not opposite the tangential with centripetal and centrifugal on their respective line of action. One example is an object moving in a circular orbit around the earth at constant velocity (tangential to its own orbit) and at the same time does fall toward to the earth perpendicularly to this tangential line of action. This may be possible the compensation of lineal withdrawal distance by free fall toward the earth. These phenomena described the centripetal force concept, that is a single unbalanced force in its line of action. In other way, only in the accelerated reference frames like rotational reference frame, take place the fictitious forces “pseudoforces” or centrifugal forces. These forces take place in the same line of action of the centripetal forces and both perpendicularly to the body tangential motion.

According to previous description it is possible a rotational reference fully independent in motion from it own axle. That would be equal to put two or more rockets equidistant to each other in a circular base and point out all of them in the same rotational direction. All rotational motion would be fully independent from it own axle. But in rocket case, when they are consumed, the gained rotational kinetic energy may be use in some application but there's no way to feed back the burned mass in the process.

Considering a balanced RM Arrangement (In next FIG. A-14) in rotational motion around an axle. All circular motion will be mechanically independent to this axle, and this circular motion will move a generator in the axle reference frame. In this case, like as previous described the RM Arrangement will increase its tangential velocity and tangential kinetic energy with an application of constant magnetic force, developed by constant electric current. The increase of centripetal and centrifugal forces by the increase in speed of each RM, does not make opposition to tangential increasing velocity and kinetic energy. If the electric energy is created in the generator located at the axle, and transferred to the Arrangement, only an amount of kinetic energy may be transformed to feed back the Arrangement. The rest kinetic energy will be remainder and will be also transformable. See FIG. A-14.

This explanation does not establish a violation of Energy Conservation Law, because this law was not conceived from motion relativity. Energy Conservation Law basically establishes losses always happening in any kind of energy transformation. Is a misconception consider a electric generator as energy transformer like batteries or solar cells, In a electric generator the energy comes from induction phenomena working together with motion, and some laws of physics are relative to the motion's reference's frame. In addition, the Energy Conservation Law dose not define the mechanics of induction phenomena.

In theory, “an appropriate construction of RM Arrangement may supply energy for a long, very long time” The heat losses and other losses in electric current supply, will be multiples times restored by the continues gained kinetic energy of the arrangement. These descriptions do not propose a Perpetual Motion Machine, because another loss like mechanical components' wear and permanent magnets power loss as well happens in a conventional generator, do not will be restored by the increasing of kinetic energy. According to this explanation, after arrangement start rotation it will produce progressively its own required energy sometime before it requires.

Can events' effects appear some time before it occurs?

Einstein's relativity answer is yes.

In his thought experiment about simultaneity, Einstein show that two simultaneous lightning reach a moving inertial observer (C′) at different time when he travel in a middle point of a train. But is not the same for an observer (C) out side of the train in the road. For him, both lightning are simultaneous events See FIG. “thoughts experiments”—15 (T-15)

What would happen if we alter this experiment introducing an electric circuit that close at the same time lightning bolt strike on (a) and (b) points of the train? This circuit will have continuity through the (C′) on board observer's arms just in the middle of the train. The electric power source will be outside the train. The conductors will be part of the rails and the left and right wheels work as brushes for close the continuity of the circuit inside and outside the train.

See FIG. T-16

Observation:

1. The electrification of the on board observer will be the first event for him and for the at rest inertial observer, understanding that electrons in the electric circuit will move at “300,000 km/s” on the electric conductors by the electric potential difference in the power source. Note that electric conductors of the circuit are in two different inertial reference frames.

2. The observer outside the train will see after both lightning simultaneously.

3. The on board observer will see the three events at different times. First, will feel current flow on his self. Second, will see light from lightning on (a). Third, will see light from lightning on (b).

4. The outside observer can measure two events' effects before he knows the existence of these events. The on board observer will feel on his self also, two events' effects before he knows the existence of theses events. This is possible because the electricity need a medium of propagation, different that light or electromagnetic waves. For the on board observer the electricity flows at 300,000km/s on his reference frame. For out side observer the on board electricity flows more slowly at time relative to (t/γ=t′), where γ is the relativistic transformation coefficient. However, the traveling distance from lightning to the observers is enormous biggest comparing to traveling distance of an electron inside the atoms when the electricity flows. In fact, in FIG. T-16 we may identify an atomic motion reference frame where for practical effects it's common for two original inertial reference frames. Different to light, the electrons do not need travel any distance to make feel it selves on the observer (C′). Because this observer is a physical part of the circuit.

The basic interpretation of Einstein about the simultaneity thought experiment is:
“For the on board observer (C′) the event of the lightning bolt on point (a) does not exist until the distance between flash and him be equal to cero”.

On our alternate thought experiment occur the same, but, the electrification of the on board observer (C′) is for him, an ahead of time effect respect to the cause. Then, the relationship between this alternate thought experiment and RM is:
“The appearance of the perpendicular force ahead to the axles is analogous to the appearance of lightning on point (a). The electrification of the onboard observer is analogous to axles' acceleration's response. Then, by analogy, the axles' acceleration is an event ahead of time to the exerted forces who make possible the wheels' motion. By Newton's Third Law, the exerted forces behind the axles are just the reaction of the forces ahead to the axles”.

According to this explanation, and different to conventional propulsion technics, the RM, respect to itself, always has in space-time its own impulse ability ahead to its own motion response. See FIG. T-17. This property implies constant acceleration and constant increase of kinetic energy at constant applied force.

Working in rotational motion, the required electromotive force (emf) in RM Arrangement's electromagnets is located always in space- time ahead to the rotational motion response, and this response produce the required emf in a different reference frame of motion.

Another simple point of view:

When a magnet is moving away from a coil, an electromotive force (emf) is induced in the coil. This is basically the electric generator principle. If a device has the property of increases its own rotational kinetic energy by application of constant emf, the logical expected effects is more than 100% of emffeedback, when rotation is used to move an emf generator. The conventional motors increase their own rotational kinetic energy, only when they increase the consumption of emf, analogous to fuel type motor that also increase their own rotational kinetic energy when they increase consumption of fuel.

Why this explanation does not violate the Energy Conservation Law? Be cause in the previous descriptions the energy dose not comes from a nonexistence empty place. The overproduction of emf comes from the “constant” magnetic force contents in the magnets, working together with the progressive inertial change of rotational RM. A permanent magnet it may be considered as an “invariant energy source”. The proposed RM Arrangement Power Source, provide a way to subtract this “invariant energy” from the permanent magnets using the previous RM's properties in the space-time.

I claim:

1) A reaction less motion method using attraction and repulsive forces between two circular reference frames (free wheels), to produce thrust in their axles without lineal opposite reaction and said thrust perpendicularly to the forces. This method comprising:
a segmented wheels in theirs circumferences, said segments comprising an electromagnets arrangement;
a polarity energizer consisting in a electricity conductors for set up the required magnetical polarities in said electromagnets arrangements;
a propulsion technic that always has in space-time, its own impulse ability behind and ahead to its own motion response, as shown in FIG. T17.

2) The use of this reaction less motion technic in any kind of application.
